(19) United States
(12) Patent Application Publication
(10) Pub. No.: US 2012/0203596 A1
(43) Pub. Date: Aug. 9, 2012

(54) DEMAND SIDE MANAGEMENT PORTFOLIO MANAGER SYSTEM

(75) Inventors: Gregory GUTHRIDGE, Vancouver (CA); Michael Dary, Vancouver (CA); Ruari Monahan, Waxhaw, NC (US); Naomi Manley-Casimir, New Westminster (CA); Kenneth Barsky, East Bend, NC (US); Zephaniah Wong, Burnaby (CA); Sylvain Bonzom, Vancouver (CA)

(73) Assignee: Accenture Global Services Limited, Dublin (IE)

(21) Appl. No.: 13/367,804

(22) Filed: Feb. 7, 2012

Related U.S. Application Data
(60) Provisional application No. 61/440,121, filed on Feb. 7, 2011.
(60) Provisional application No. 61/440,520, filed on Feb. 8, 2011.

(51) Int. Cl. G06Q 10/04; G06Q 10/06

(52) U.S. Cl. 705/7.37

(57) ABSTRACT

A demand side management (DSM) portfolio manager system for processing DSM data to implement DSM programs for an energy service provider includes a DSM workflow management module. The DSM workflow management module may determine a workflow plan for processing the DSM data throughout phases of a DSM portfolio lifecycle to create and evaluate the DSM programs for the energy service provider. The system includes a DSM evaluation, measurement and verification module to evaluate the DSM programs. The evaluation may include determining key performance indicators for the DSM programs based on the DSM data and comparing the DSM programs to benchmarks and analyzing the DSM data for the DSM programs utilizing performance-based analytics to predict future performance of the DSM programs. A DSM reporting module may report results of the evaluation in a dashboard.

### PRIORITY

The present application claims priority to U.S. Provisional Patent Application Ser. No. 61/440,121, filed on Feb. 7, 2011, entitled “Combined Analytics Applications System”, and to U.S. Provisional Patent Application Ser. No. 61/440,520, filed Feb. 8, 2011, which are both incorporated by reference in their entireties.

### CROSS REFERENCE TO RELATED APPLICATIONS

The present application is also related to U.S. patent application Ser. No. 13/267,620, filed on Oct. 6, 2011, entitled “Eco Score Analytics System”, the disclosure of which is hereby incorporated by reference in its entirety.

### BACKGROUND

Energy conservation and greenhouse gas emission reduction are important for individuals and entities of all sizes, from small corporations and non-governmental entities to large multinational conglomerates and governments at all levels. By decreasing the total energy consumption of consumers, or by influencing consumers to adopt more efficient energy types (i.e., “green” energy sources), energy conservation grows and greenhouse gas emission may be reduced. Another factor is that increased energy conservation indirectly enhances the development of renewable energy sources.

Many factors can influence how energy is utilized by individual consumers, entities, and segments of the population. The consumption of energy and/or other resources may be minimized through influencing certain consumer behaviors, especially consumer behaviors associated with high consumption or waste. One way by which consumer behaviors may be influenced is through information and educational campaigns and energy conservation programs to targets (e.g., individuals, entities, and/or population segments) which consume energy and/or other resources. Campaigns and programs having these goals are often called demand side management (DSM) programs.

In recent years, utilities have engaged in an array of disparate technologies and systems that have been custom built to enable DSM programs. For example, a utility may utilize smart metering applications, energy distribution management systems, mobile workforce utility systems, energy marketing campaign systems, billing systems and other types of systems to manage energy consumption and engage in DSM. However, these systems are often not integrated, which creates significant challenges for effective workflow and energy program management.

For example, fragmented data is often stored across multiple heterogeneous systems, requiring significant additional time and expense to consolidate it into a usable data format. As a result, it can be difficult to aggregate data generated across these various systems for reporting and analysis of consumer energy behavior and energy programs which may be currently implemented for DSM. Additionally, integration of data from these disparate DSM systems often results in redundant manual processes and/or a lack of standard business configurable tools, which often results in operational inefficiencies and a higher cost of DSM administration.

### SUMMARY

According to an embodiment, a demand side management (DSM) portfolio manager system is operable to process DSM data to implement DSM programs for an energy service provider. The system includes a DSM workflow management module to determine a workflow plan for processing the DSM data throughout phases of a DSM portfolio lifecycle for creating and evaluating the DSM programs for the energy service provider. The phases of the DSM portfolio lifecycle may include strategy and assessment, program planning and design, delivery and execution, and evaluation, measurement and verification. The system may include a DSM evaluation, measurement and verification module to evaluate the DSM programs in the evaluation, measurement and verification phase of the DSM portfolio lifecycle, wherein the evaluation of the DSM programs includes determining key performance indicators for the DSM programs based on the DSM data and comparing the DSM programs to benchmarks. The evaluation further includes analyzing the DSM data for the DSM programs utilizing performance-based analytics to predict future performance of the DSM programs. The system may also include a DSM reporting module to report results of the evaluation in a user interface, which may include a dashboard.

A DSM method for processing DSM data through phases of a DSM portfolio lifecycle includes determining types of DSM programs to implement for an energy service provider based on information about the energy service provider and based on DSM data collected for a plurality users related to DSM programs that have previously been implemented. The method further includes determining details of the DSM programs to implement, collecting DSM data after implementing the DSM programs, evaluating the DSM programs, and reporting results of the evaluation via a user interface. The evaluation of the DSM programs may include determining key performance indicators for the DSM programs based on the collected DSM data, comparing the DSM programs to benchmarks, and analyzing the DSM data for the DSM programs utilizing performance-based analytics to predict future performance of the DSM programs.

The methods and functions described herein may be embodied in machine readable instructions stored on a computer readable medium. The machine readable instructions may be executed by a processor to perform the methods and functions described herein.

### BRIEF DESCRIPTION OF THE DRAWINGS

Embodiments are described in detail in the following description with reference to the following figures. The embodiments are illustrated by way of example and are not limited by the accompanying figures in which like reference numerals indicate similar elements.

FIG. 1A is a system diagram illustrating a cloud-based context for a Demand Side Management (DSM) portfolio manager system;

FIG. 1B is a system diagram illustrating an on-premises context for the DSM portfolio manager system;

FIG. 2 illustrates an architecture of the DSM portfolio manager system;

FIG. 3 illustrates a block diagram of the DSM portfolio manager system;

FIG. 4 illustrates a flow diagram illustrating a method of utilizing the

DSM portfolio manager system;

FIG. 5 illustrates a flow diagram of a method of performing processes throughout a DSM portfolio lifecycle;

FIGS. 6A-C illustrate flow diagrams for DSM auditing, claim rebate processing and providing educational information for DSM;

FIG. 7 illustrates a system diagram for a Combined Analytics

FIG. 8 illustrates a block diagram of the CAA system;

FIG. 9 illustrates types of application attributes that may be used by the CAA system;

FIG. 10 illustrates a flow diagram of a method of utilizing the CAA system;

FIG. 11 illustrates a graphical representation of a suite of applications that may be provided by the CAA system; and

FIG. 12 illustrates a computer system platform for the DSM portfolio manager system and/or the CAA system.

### DETAILED DESCRIPTION

For simplicity and illustrative purposes, the principles of the examples are described by referring mainly to examples thereof. In the following description, numerous specific details are set forth in order to provide a thorough understanding of the examples. It is apparent however, to one of ordinary skill in the art, that the examples may be practiced without limitation to these specific details. In some instances, well known methods and structures have not been described in detail so as not to unnecessarily obscure the examples. Furthermore, different examples are described below. The examples may be used or performed together in different combinations.

According to an embodiment, a demand side management (DSM) portfolio manager system streamlines and improves the processing efficiency, accuracy, reporting and analytical capabilities for DSM programs related to energy management, energy efficiency and energy conservation. A DSM program may include actions, typically performed by an energy service provider, related to consumption of energy by its customers or other consumers. In one example, a DSM program includes an electricity management program that allows the energy service provider to control smart appliances to reduce demand, for example, at peak times. Another example, may include education and financial incentives to adopt green technologies, such as solar or wind, or promote and sell energy efficient products. Other types of DSM programs may be implemented. Energy service providers may include utilities or other companies or entities, providing services and/or commodities to address DSM.

The DSM portfolio management system is operable to gather data from multiple sources to provide a single source of data to support DSM program design, energy marketing campaign analysis and evaluation, and measurement and verification of DSM programs. The DSM portfolio manager system reduces the costs associated with poor quality data sourcing by operating as a single source of data to support DSM program design, marketing campaign analysis, and the DSM processes of evaluation, measurement and verification. Also, the DSM portfolio management system, through its evaluation, measurement and verification of DSM programs, provides reporting and insight into program effectiveness, benefits, costs and operational efficiencies to maximize adoption of the most effective consumer energy conservation programs. The DSM portfolio manager system may perform prescriptive and predictive analytics to evaluate the DSM programs. Generally, through the various functionalities of the DSM portfolio manager system, the system addresses the challenges that energy service providers face in successfully designing, implementing and running DSM programs.

The DSM portfolio manager system may also be used in the modification of consumer demand for energy. For example, the DSM portfolio manager system evaluates the effectiveness and quality of DSM programs, which may be aimed at energy conservation, and may promote the adoption of energy efficient products and appliances, such as stoves, washer/dryers, air conditioning units, etc. Also, the DSM portfolio manager system may be used to encourage consumers to use less energy during peak hours, or to move the time of energy use to off-peak times such as nighttime and weekends. The DSM portfolio manager system may also be used to reduce the need for investments in power networks and/or power plants.

The DSM portfolio manager system also includes a workflow management tool to aid energy service providers in their activities throughout a DSM portfolio lifecycle. A DSM portfolio may include a multitude of DSM programs and activities that are generated and implemented by an energy service provider. Examples of phases in the lifecycle may include strategy and assessment, program planning and design, delivery and execution, and evaluation, measurement and verification. The workflow management tool guides the energy service provider through the processes that are performed at each phase of the lifecycle. The workflow management tool may include customizable templates to support implementation of the processes in each phase of the lifecycle. The templates can integrate different industry standards for DSM program workflows.

The DSM portfolio manager system also provides a platform for vendor management functionality. The functionality may include the ability to manage vendors and cost structures.

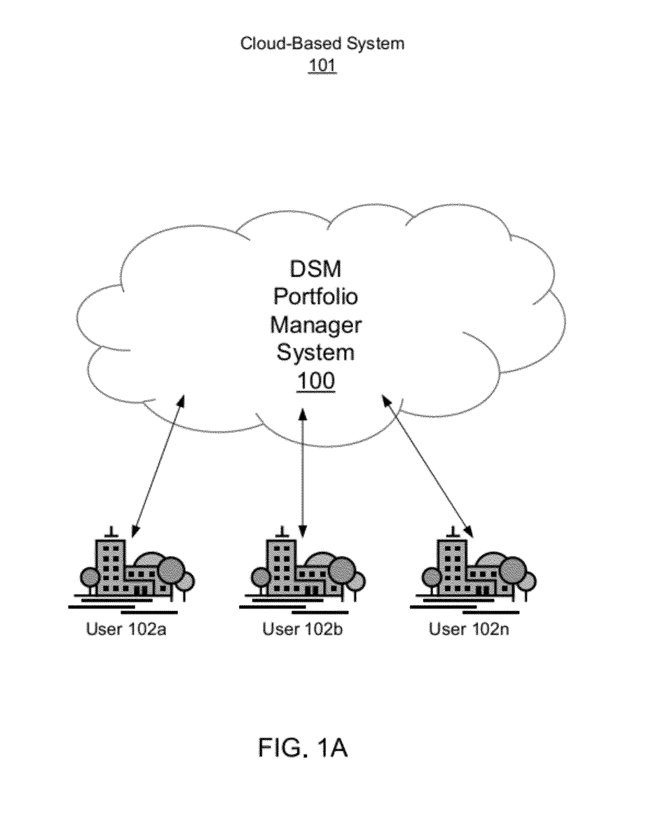

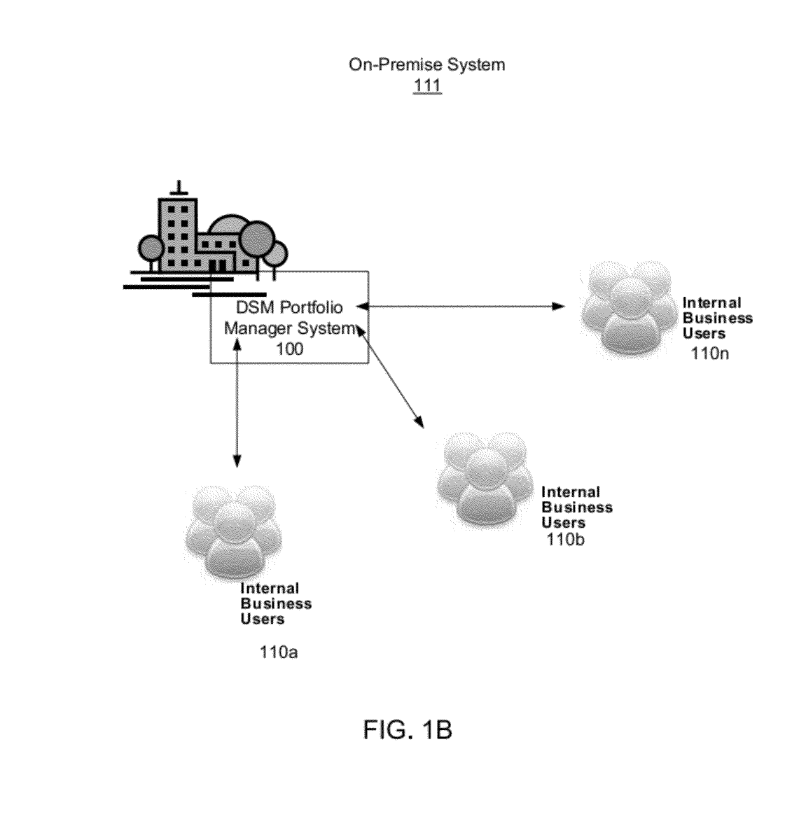

The DSM portfolio manager may be implemented in a cloud-based system and/or in an on-premise system to provide software service solutions related to DSM. The service solutions may include the services described above, such as DSM workflow management, vendor management, operating as a single source of data to support DSM program design, marketing campaign analysis, and the DSM processes of evaluation, measurement and verification of DSM programs, and other services. FIG. 1A illustrates a cloud-based system 101 for a DSM portfolio manager system 100, according to an embodiment. The cloud-based system 101 may include a distributed computing system, which comprises computers hosting applications providing the DSM software services and computers storing the data for the services. The computers may be geographically distributed or provided at a single remote location, such as a data center. The users 102a-n, for example, are utilities or other energy service providers. The DSM portfolio manager system 100 may deliver the DSM software services via the Internet or private networks, which can be accessed from web browsers or mobile apps at the users 102a-n. The DSM software services may be provided as metered services over the Internet.

FIG. 1B illustrates an on-premises system 111 for the DSM portfolio manager system 100, according to an embodiment. In this embodiment, the various internal users 110a-n at a utility company communicate with the DSM portfolio manager system 100 in an on-premises environment at the utility company as depicted in FIG. 1B. The utility company provides the computer platform to host the DSM portfolio manager system 100. The users 110a-n may communicate with the DSM portfolio manager system 100 via a network.

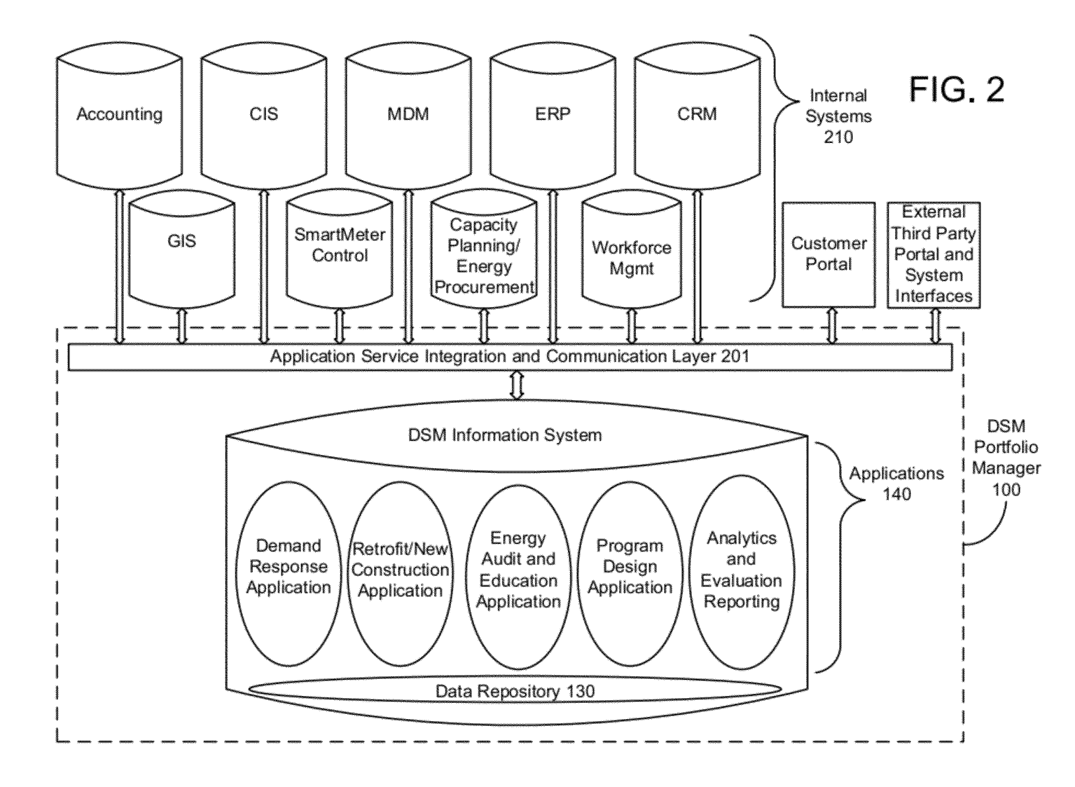

FIG. 2 shows an example of an architecture for the DSM portfolio manager system 100, according to an embodiment. The architecture includes an application service integration and communication layer 201 that supports data collection from the internal systems 210 of a user, which may include enterprise applications of a utility company. The layer 201 also provides secured access with user/customer portals, including external third party portals and systems. The layer 201 may utilize a full featured web services library to support utility or vendor managed portals for customers or third parties.

The layer 201 provides a mechanism for interfacing with the internal systems 210 so the DSM portfolio manager system 100 can function as a single source of data to provide its DSM services. The layer 201 supports high-level transactional data collection as well as more complex data collection from enterprise resources. The layer 201 may include application program interfaces (APIs) to communicate with the internal systems 210. For example, the internal systems 210 may include enterprise applications providing functions for accounting, customer information system (CIS), e.g., used for billing customers for energy usage, meter data management, enterprise resource planning (ERP), customer relationship management (CRM), geographic information system (GIS), e.g., linking geographic locations to data, smart metering, capacity planning, workforce management, etc. The layer 201 receives data from the enterprise applications, for example, through APIs or other interfaces and may normalize the data for storage in a data repository 130 for the DSM portfolio manager system 100. Normalizing may include formatting according to predetermined specifications. The DSM portfolio manager system 100 may include a DSM information system providing the data repository 130 and applications 140 providing the services of the DSM portfolio manager system 100. Examples of the applications 140 may include a demand response application, retrofit/new construction application, energy audit and education application, program design application, and analytics, evaluation and reporting applications. The demand response application manages customer consumption of energy, for example, in response to supply conditions. This may include managing smart appliance systems to curtail customer demand at critical times or in response to market price. The retrofit/new construction application may be used for the construction of data models and databases for prescriptive, customized, promotional, educational, and audit program administration. The energy audit and education application and the program design application may be used to create, administer and track customized DSM programs. The DSM programs may include educational programs regarding energy conservation, financial incentive programs to promote energy conservation, etc. The analytics, evaluation and reporting applications may be utilized from the initial input to final approval for prescriptive, customized, educational, and audit programs. It may be used for performance-based analytics and for reporting.

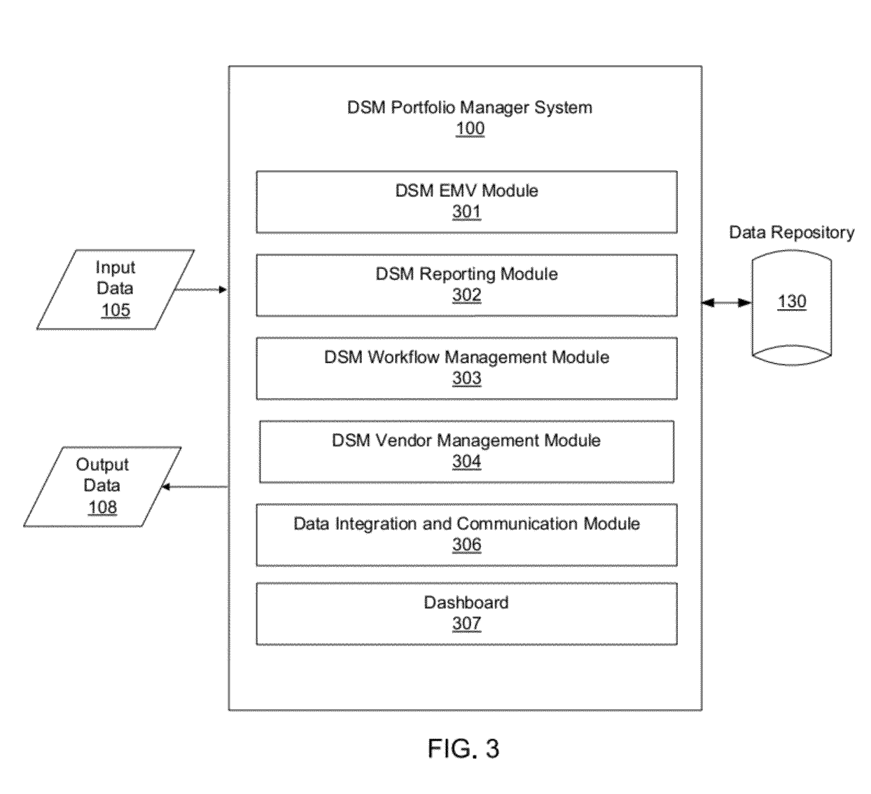

FIG. 3 shows a functional block diagram of the DSM portfolio manager system 100. The DSM portfolio manager system 100 may include a DSM evaluation, measurement and verification (EM&V) module 301, a DSM reporting module 302, a DSM workflow management module 303 and a DSM vendor management module 304. The modules 301-304 provide the functionality of the DSM portfolio manager system 100, which includes the functionality of the applications 140 shown in FIG. 2 and other functionalities. The modules in the DSM portfolio manager system 100 may include software modules executed by one or more processors. The DSM portfolio manager system 100 may also include a data integration and communication module 306 providing the functionality for the layer 201 shown in FIG. 2, and a data repository 130 storing data used by the DSM portfolio manager system 100. The DSM portfolio manager system 100 may include a dashboard 307, which is a user interface.

The DSM portfolio manager system 100 receives input data 105 which may be associated with DSM programs. The input data 105 may include data generated by the internal systems 210 shown in FIG. 2. The input data 105 may include data from other sources as well. For example, the input data 105 may include demographics provided from public databases, weather and climate information, which may be used to forecast demand, real estate information which may provide insight into demographics and demand, and other information. Customer satisfaction information, financials, firmographics (characteristics of an organization), and other information may be provided from the internal system 210.

The input data 105 and output data 108 may be stored in the data repository 130. The modules 301-304 generate the output data 108. The output data 108 may include reporting of key performance indicators (KPIs) associated with DSM programs, such as generated by the DSM EMV module 301. The output data 108 may include information associated with workflow and vendor management, such as generated by the DSM workflow management module 303 and the DSM vendor management module 304. The output data 108 may be viewed via the dashboard 307. The modules 301-304 are now further described.

The DSM portfolio manager system 100 may be used to streamline and improve the processing efficiency, accuracy, reporting and analytical capabilities of DSM program activities around energy management, energy efficiency and conservation. For example, the DSM EMV module 301 may be utilized to analyze the input data 105 to evaluate and forecast energy demand, customer behavior towards DSM programs, sales effectiveness, and other information related to DSM. The DSM EMV module 301 may employ analytics for the analysis. Furthermore, the DSM EMV module 301 may determine KPIs for different DSM programs to evaluate how the effectiveness of each DSM program in reaching user goals, such as maximizing energy conservation, reducing peak-time demand, increasing adoption of green technologies, etc. Also, the input data 105 received from various sources may be standardized and formatted to a uniform model to provide more meaningful information to the user in planning and executing campaigns, such as campaigns for energy management, energy efficiency and conservation.

In one example, the DSM EMV module 101 may utilize input data stored in the data repository 130 to identify information gaps or to forecast information needs to enhance a goal associated with a proposed DSM program, such as an effort to change energy usage at a given peak time frame, or to promote adoption of a specific energy efficiency appliance. A proposed DSM program may then be developed and implemented, for example, through the DSM workflow management module 103. The proposed DSM program may be directed to any DSM goal, such as promoting the adoption of energy efficient products and appliances, such as stoves, washer/dryers, air conditioning units, etc.

The DSM EMV module 101 may be used in DSM marketing campaign analysis. After a marketing campaign for a DSM program has been implemented, the DSM portfolio manager system 100 may be utilized to gather data from the separate DSM programs associated with the marketing campaigns, which may then be analyzed utilizing the DSM EMV module 101. The DSM EMV module 101 may then be utilized in evaluating the effectiveness and quality of DSM program activities, for example, through comparison of KPIs and other metrics.

The DSM workflow management module 303 aids energy service providers in their activities throughout a DSM portfolio lifecycle. Examples of phases in the lifecycle may include strategy and assessment, program planning and design, delivery and execution, and evaluation, measurement and verification. The DSM workflow management module 303 guides the energy service provider through the processes that are performed at each phase of the lifecycle. The DSM workflow management module 303 may include customizable templates to support implementation of the processes in each phase of the lifecycle. The templates can integrate different industry standards for DSM program workflows.

In each phase of the lifecycle, the DSM workflow management module 303 gathers data from the user and from the data repository 130 that is pertinent to the phase to make decisions for the phase. For example, for strategy and assessment, information may be gathered regarding industry regulations, customer financials, user goals, etc., to develop a strategy to create, implement, and verify a portfolio of DSM programs that are optimized for the user (e.g., an energy service provider). In the program planning and design phase, data models and DSM programs are created. In the delivery and execution phase, the DSM programs are implemented, and data gathering related to DSM programs is performed. In the evaluation, measurement and verification phase, analytics and reporting are performed. The DSM workflow management module 303 may interface with the DSM EMV module 301 for performing analytics, and may interface with the DSM reporting module 302 for reporting, for example, via the dashboard 307.

The DSM reporting module 302 generates reports, which may present KPIs and other information for analyzing effectiveness of DSM programs. The reports may also provide the output of analytics performed by the DSM EMV module 301. A user may be able to customize reports to show different KPIs and metrics.

The DSM vendor management module 302 determines integration options for integrating vendor systems with the DSM portfolio manager system 100. For example, a vendor may supply software for tracking and delivery for DSM programs that supports energy audits, energy efficiency rebates, and demand response enrolments and events. The DSM vendor management module 302 may determine information for interfacing the software with the DSM portfolio manager system 100. The DSM vendor management module 302 may also be used to manage vendor costs.

The dashboard 307 provides the user interface, where the user may enter data into the DSM portfolio manager system 100 and may view data generated by the DSM portfolio manager system 100. The dashboard 307 may include a graphical user interface.

In addition to the functions described above, the DSM portfolio manager system 100 may be utilized to manage core operations and services; to manage supply, field operations requests, and segmentation; to manage quality and performance and third party interactions; and to monitor performance and customer advocacy.

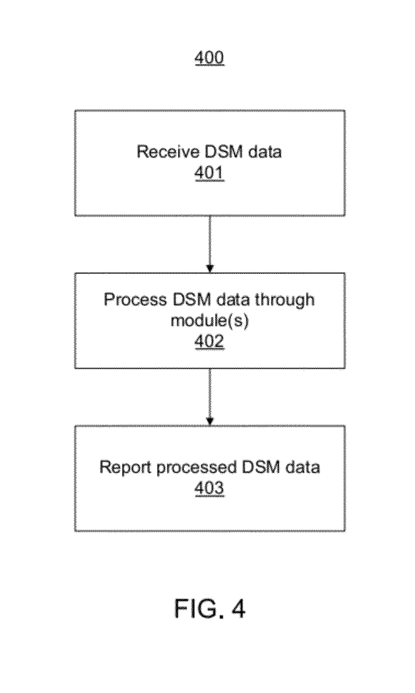

A method 400, as illustrated in FIG. 4, is for processing DSM data associated with a user, such as a utility company or other energy service provider.

The method 400 and other methods described herein are described with respect to the DSM portfolio manager system 100 shown in FIG. 3 by way of example and not limitation.

At block 401, the DSM portfolio manager system 100 receives the DSM data. The DSM data may be any data related to DSM, including input data 105 shown in FIG. 2.

At block 402, the DSM portfolio manager system 100 processes the DSM data through at least one module in the DSM portfolio manager system 100. These modules in the DSM portfolio manager system 100 may include the DSM workflow management module 303, the DSM vendor management module 304 and the DSM EMV module 301.

The DSM data may be processed utilizing the DSM EMV module 301 for a wide array of utilizations. For example, the DSM data may be processed to be used in modifying the processing efficiency, accuracy, reporting and analytical capabilities of DSM programs. In another example, a plurality of DSM data streams from separate DSM programs are evaluated to determine how data from the separate DSM systems may be formatted and coordinated through the DSM portfolio manager system 100. In another example, the DSM data may be processed to identify information gaps or forecast information needs to enhance a goal associated with a proposed DSM program. In another example, the DSM data may be processed to be utilized in evaluating the effectiveness and quality of DSM program activities.

At block 403, the processed DSM data is reported utilizing the DSM reporting module 302 which is included in the DSM portfolio manager system 100. Reporting may be performed via the dashboard 307.

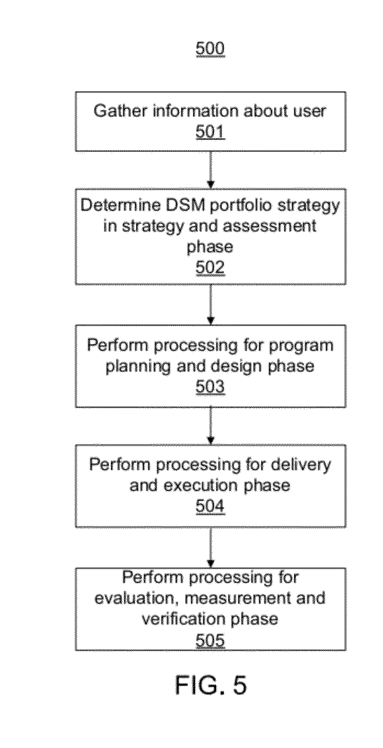

FIG. 5 illustrates a method 500 according to an embodiment for workflow processing. The method 500 may be performed by the DSM workflow management module 303 and other modules shown in FIG. 3 for the DSM portfolio manager system 100. The method 500 describes DSM data processing performed throughout the phases of the DSM portfolio lifecycle. The phases include strategy and assessment, program planning and design, delivery and execution, and evaluation, measurement and verification.

At block 501, information about the user is gathered. The user is a user of the DSM portfolio manager system 100. The user may be an energy service provider that wants to implement and manage a portfolio of DSM programs. The information about the user may include the type of user, financials of the user, goals of the user, customer demographics, geographic location of user and customers, or any other information related to the user. This information may be stored in the data repository 130 shown in FIG. 3. At least some of the information may be provided to the DSM portfolio manager system 100 from the internal systems of the user. Also, the DSM portfolio manager system 100 may present online questionnaires to the user, e.g., via dashboard 307, to gather the information.

At block 502, a DSM portfolio strategy is determined based on the information gathered for the user and based on analysis of historic DSM data for a multitude of users. For example, the data repository 130 may include a data warehouse storing DSM data for multiple users. The DSM portfolio strategy may include a determination of types of DSM programs to implement for the user, development of a workflow management plan for managing the DSM programs throughout the phases of the DSM portfolio lifecycle, and identification of analytics to be used at different phases of the DSM portfolio lifecycle.

Analysis of historic DSM data for a multitude of users may be used to determine the DSM portfolio strategy for a user. For example, the analysis may identify DSM programs that were successful in the past and identify attributes of the energy service providers and their customers that participated in the successful DSM programs. Attributes of the user determined at 501 may be matched with the attributes associated with successful DSM programs to identify DSM programs that may be successful for the user.

For example, the data repository 130 may store DSM data for a multitude of users. The DSM portfolio manager system 100 may be analyzed to determine models for evaluating the effectiveness of DSM programs based on a plurality of variables, such as customer demographics, geographic location, services provided, etc. The models may comprise relationships between the variables and KPIs for measuring effectiveness of DSM programs. These relationships may be determined through multivariate statistical processing, such as multivariate regression analysis, multivariate analysis of variance, principal components analysis, etc. These models may also be used for forecasting in predictive analytics. Based on the attributes and goals of the user and the models, one or more types of DSM programs may be selected to be implemented for the user. For example, one or more of prescriptive, customized, educational and/or audit DSM programs may be selected. The DSM portfolio manager system 100 determines the recommendations for different types of DSM programs based on the analysis of historic data, and the recommendations may be presented to the user via the dashboard 207. The user may select one or more types of DSM programs to implement.

At block 503, in the program planning and design phase, the details for the DSM programs are determined. For example, if prescriptive DSM programs are selected at 502 to reduce demand at peak times, then a DSM program may be designed that allows the energy service provider to control energy consumption at those times. This may include a DSM program that allows the energy service provider to control appliances, such as air conditioners, at the customer premises to reduce demand. The models described above at 502 may be used to identify at least some of the details, such as the amount of financial incentive for program participation, demographics of customers likely to participate, etc. Additional details may be entered by the user via the dashboard 307 shown in FIG. 2.

Also at block 503, the sources of DSM data relevant to the DSM programs are identified, and a data model may be created for storing the DSM data. For example, for peak demand reduction, a data source may be an application at the energy service provider monitoring demand, and smart meters at the customer premises monitoring individual usage. Data collection from the sources is integrated into the application service integration and communication layer 201 shown in FIG. 2. Also, the collected DSM data is formatted for the data model. The data model may include a schema including the types of data to be collected from the sources and the format of the data. The DSM portfolio manager system 100 may present options to the user for selecting the data to be included in the data model. Also, the user may define KPIs or other metrics. For example, the user may enter formulas for calculating metrics based on the collected data. These are custom metrics which may be used for analysis of effectiveness of programs.

Also, at block 503, the DSM programs that are designed may include marketing campaigns to promote other DSM programs and/or to educate customers on energy conservation. The DSM portfolio manager system 100 may present options for different marketing channels, such as email, text, social networking applications, etc. Also, the DSM portfolio manager system 100 may recommend demographics for targeted marketing campaigns.

At block 504, during the delivery and execution phase, the DSM programs are implemented. This may include integrating options for data collection, such as generating and providing APIs in the application service integration and communication layer 201, setting up scripts for downloading data from external sources, etc. Also, the application service integration and communication layer 201 may be extended to interface with third-party vendors, such as for demand response smart control, home or facility auditing, etc.

Performance-based analytics and reporting are also setup. For example, the user selects the type of performance-based analytics to be performed on the collected DSM data. Also, the DSM portfolio manager system 100 may present templates to the user for reporting. The user may modify the templates to provide reporting in the desired format.

At block 505, the evaluation, measurement and verification phase is implemented. This may include measuring the effectiveness of programs through collected DSM data and reporting. KPIs defined, for example, at block 503 may be used for measuring effectiveness. Performance-based analytics are performed to forecast performance of the DSM programs. Also, the DSM programs are compared with each other and with DSM programs for other users for performance benchmarking. Prescriptive analytics may be performed for under-performing programs to identify how to improve performance.

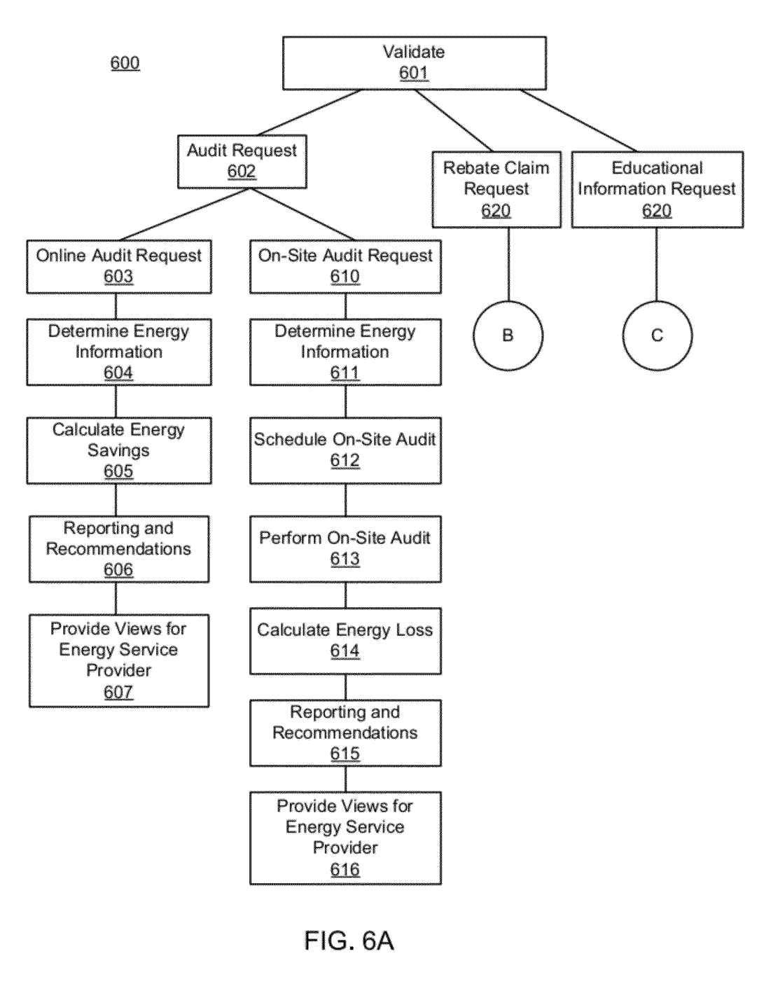

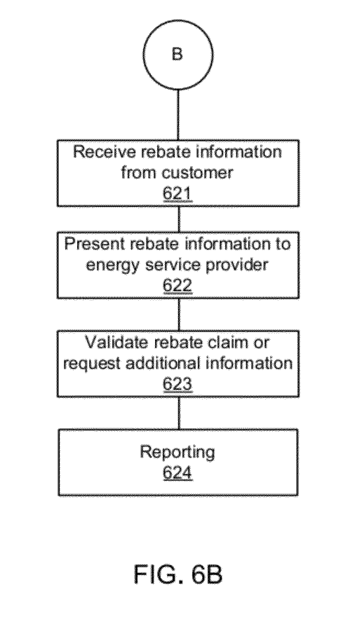

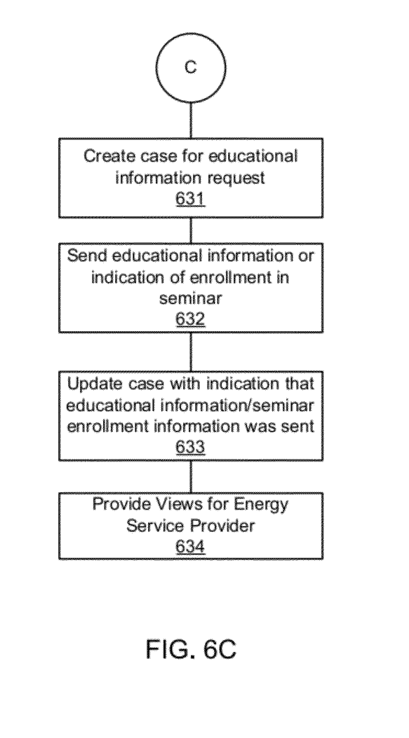

FIG. 6A-C illustrates a method 600 according to an embodiment for DSM auditing, rebate claims processing, and providing educational information for DSM. The method 600 may be performed by the DSM workflow management module 303 and other modules shown in FIG. 3 for the DSM portfolio manager system 100.

At block 601, an energy customer is validated. The customer may be a customer of an energy service provider. In one example, the customer logs into a customer portal, such as the customer portal shown in FIG. 2, and the DSM portfolio manager system 100 validates the customer. The customer portal may be a graphical user interface accessed via the Internet or another network. The customer may interface with the DSM portfolio management system 100 via the customer portal to provide information and receive information related to auditing, rebate claims processing, and educational information for DSM. The validation may include verifying the customer is registered with the energy service provider and has an account with the energy service provider.

After the customer is validated, the customer sends a request to the DSM portfolio manager system 100, for example, for an audit, a rebate, or educational information for energy conservation and energy savings. In one example, the customer selects whether the request is for an audit, a rebate, or educational information via the customer portal. Block 602 represents that the request is for an audit request. If an audit request is selected, the customer may select whether the audit request is for an online audit request (block 603) or an on-site audit request (block 610). If an online audit request is received, information related to energy use by the customer is determined at block 604. For example, the customer provides information related to the appliances at the premises, including appliance type (e.g., air conditioner, heater, washer, dryer, etc.), manufacturer, model, and age. Other information may also be received or otherwise determined at block 604, including information about the type of premises (e.g., single-family home, condominium, etc.), size of premise, information related to insulation, current amount of energy usage, etc.

At block 605, the DSM portfolio manager system 100 calculates potential energy savings. For example, for each appliance, the DSM portfolio manager system 100 determines or estimates current energy consumed based on the information for each appliance and also calculates an estimate of energy cost savings for each appliance. The energy cost savings may be based on replacing the appliance with a more energy efficient appliance.

At block 606, reporting and recommendations are provided to the customer. The reporting may include a report of the energy cost savings for the customer. Recommendations may include recommendations for DSM programs to enroll in. For example, the recommendations may identify DSM rebate programs that provide rebates if the user installs an approved energy efficient appliance. For example, if cost savings for a washer or dryer is greater than a threshold, then a recommendation for a rebate program for an energy efficient washer and dryer is provided to the customer. Also, recommendations may include providing information on how to improve energy conservation and recommendations for enrolling in certain educational programs. Also, the reporting to the customer may include an estimate of the average energy and cost savings associated with each recommended action and payback period (time it takes to recoup the investment of action implementation through associated energy cost savings. The reporting may include a comparison of the current energy usage to benchmarks for the same type of customer and premises/facility.

At block 607, the energy service provider may log into the DSM portfolio manager system 100 to view case summaries or aggregated results of audits. Also, the DSM portfolio manager system 100 may store customer relationship management (CRM) data, including customer account and contact information. A user from the energy service provider viewing case summaries, for example via dashboard 307, may click on customer audit data and automatically access customer contact information so the user can send information to the customer, such as information about DSM programs. Also, queries may be executed on the audit data for the customers to identify and send information to customers that may be interested in various DSM programs.

A customer may select an on-site audit instead of an online audit. For example, at block 610, the DSM portfolio manager system 100 receives a request for an on-site audit. At block 611, the DSM portfolio manager system 100 determines information related to energy use by the customer. This information may include information regarding the type of premises (e.g., residential, commercial, single-family home, multi-dwelling home, etc.), size of premise, information related to insulation for walls, floors, attic, pipes, windows, etc., number and type of windows, current amount of energy usage, etc. This information may be provided by the customer with the request or subsequent to the request. At block 612, the DSM portfolio manager system 100 uses CRM data for the customer to contact and schedule the on-site audit. At block 613, the on-site audit is performed. The on-site audit may verify information provided by the customer at block 611 and may take further measurements and determine other metrics related to energy use by the customer. An auditor goes to the premises to perform the measurements and determine energy usage information, and the information is input into the DSM portfolio manager system 100 for storage.

At block 614, the DSM portfolio manager system 100 calculates estimates of the current energy loss and potential future energy loss based on the information determined at blocks 611 and 612. Current energy loss may be determined for different areas of the premises. For example, current energy loss may be determined for the attic, doors, floors, walls water pipes, windows, etc., based on insulation and measurements (e.g., heat loss) performed during the audit. Future energy loss may be based on the current energy loss and other metrics that may influence energy loss, such as estimates of increase in energy loss determined as a function of age of the premises, windows, etc.

At block 615, reporting and recommendations are provided to the customer. Recommendations may include adjusting/changing/adding controls, equipment replacement, equipment removal, building materials additions or changes, etc. Also, an estimate of the average energy and cost savings associated with each recommended action and payback period (time it takes to recoup the investment of action implementation through associated energy cost savings) can be provided in a report to the customer. The reporting may include a comparison of the current energy usage to benchmarks for the same type of customer and premises/facility. Recommendations may also include recommendations for DSM programs to enroll in.

At block 616, the energy service provider may log into the DSM portfolio manager system 100 to view case summaries or aggregated results of on-site audits, similar to block 607. A user from the energy service provider viewing case summaries, for example via dashboard 307, may click on customer audit data and automatically access customer contact information so the user can send information to the customer, such as information about DSM programs. Also, queries may be executed on the audit data for the customers to identify and send information to customers that may be interested in various DSM programs.

FIG. 6B shows steps for rebate claim processing. For example, the DSM portfolio manager system 100 receives a request for rebate claim processing from a customer at block 620 shown in FIG. 6A. Further steps are shown in FIG. 6B. At block 621, rebate information is received from the customer. For example, the customer enters the rebate information via the customer portal in an online form. The rebate information may include customer information, appliance purchased, electronic copy of receipt, etc. The rebate information may include any information that proves the customer is compliant with required actions to receive the rebate. At block 622, the DSM portfolio manager system 100 presents the rebate information to the energy service provider. For example, a use of the energy service provider views the rebate information via dashboard 307. The DSM portfolio manager system 100 may present a view of all open claims via the dashboard 307. The list may include all rebates waiting for approval. A claim is a request for rebate and may include the rebate information. The user of the energy service provider may select a particular claim to view details on the claim.

At block 623, the DSM portfolio manager system 100 stores an indication of whether the claim is validated or if additional information is needed from the customer. For example, the user validates the claim if all the information necessary to grant the rebate is provided and the DSM portfolio manager system 100 stores an indication that the rebate is validated. If the user needs additional information from the customer, then the DSM portfolio manager system 100 may generate an email or another form of electronic request to send to the customer. The user provides text for the request and it is sent to the customer.

In some instances, validation of a claim may be a multi-phase process. Also, the DSM portfolio manager system 100 may calculate the claim amount owed to the customer. For example, a rebate claim may be for a project, such as replacing all the refrigerators in a building. The DSM portfolio manager system 100 may store milestones for the project. For example, milestones may be at 33%, 66% and 100% completion of installation of the refrigerators. At each milestone, the DSM portfolio manager system 100 may calculate the claim amount to be paid to the customer for achieving the milestone. For example, one third of the total rebate amount is paid at each milestone in the case where milestones may be at 33%, 66% and 100% of completion of installation. In another example, partial rebate payment may be made after the customer indicates that certain actions were performed. Then, final payment may be made after inspection of installation or inspection of completion of the required actions for the rebate is performed. The dashboard 307 may generate views indicating the phase of completion of a project, a partial payment owed or paid, calculation of a claim, and/or whether a claim or partial payment has been validated or is waiting to be validated. In another example, claim calculations may be based on metrics determined based on the actions performed by the customer for the rebate program. For example, the rebate may be based on the amount of reduction of energy usage by the customer or based on the amount of improved heating and cooling efficiency achieved by the customer.

For payment processing, the DSM portfolio manager system 100 may automatically generate a payment record for each payment and validation phase. The payment record may be set to a status of planned, until it is processed during, e.g., a nightly batch that sends the payment to an ERP system for processing. Then, the payment status becomes pending. The nightly batch process updates the status of payment records to a paid status once the payment has been sent out.

At block 624, the DSM portfolio manager system 100 accesses stored CRM data to report to the customer. For example, the email address of the customer is retrieved to generate an email to the customer to provide the reporting. The reporting may indicate the claim is approved and payment will be made to the customer or it may include a denial of the claim and/or a request for additional information if the claim is not approved. Rebate payment amount may also be indicated to the customer. Through the dashboard 307, the user may view metrics regarding the rebate processing, such as the time it takes to approve rebates at different phases of the approval process, the amount of claims for different rebate programs, an amount of funding that remains for each rebate program, an estimate of energy conserved for each rebate program and energy savings (e.g., peak kilowatt hour savings, thermal units conserved, etc.).

In FIG. 6A, at block 630, the DSM portfolio manager system 100 receives a request for educational information for energy conservation. This may include a request for enrollment in an energy conservation seminar. As shown in FIG. 6C, at block 631, the DSM portfolio manager system 100 creates a case for the request that includes information for the request. The case may include CRM information for the customer or a potential customer, a case title and a case type. The case title and type may be associated with the type of requested information, such as whether the request is for a seminar or for information from customer service or for general information regarding energy conservation. If the customer selects a specific seminar for enrollment, that information is provided in the case. The DSM portfolio manager system 100 may present recommendations for certain seminars to attend that is relevant to the customer or is relevant to the type of information requested by the customer. At block 632, the DSM portfolio manager system 100 sends a reporting of the requested educational information to the customer or sends an indication of enrollment in a seminar. At block 633, the DSM portfolio manager system 100 stores an indication with the case that the requested educational information was sent to the customer or that an indication of enrollment in a seminar was sent to the customer. At block 634, the DSM portfolio manager system 100 may present views to a user of the energy service provider regarding the requests, such as percentage of attendance at seminars, whether energy conservation actions were performed by the customers as a result of the education information or the seminars, etc.

According to an embodiment, a combined analytics applications (CAA) system may include a suite of applications, including the DSM applications described above. The applications may include analytics with respect to basic segmentation, energy savings program adoption (EcoScore), revenue optimization, multi-channel cost optimization, other utility program adoption, acquisition and retention, lifetime valued customer, and customer behaviors. The CAA system may leverage existing analytics technologies to provide an efficient and effective software as a service solution. The CAA system may provide its users with a cloud-based software as a service solution to provide on-demand scalability, cost reduction, and short implementation cycles to users, such as utility companies.

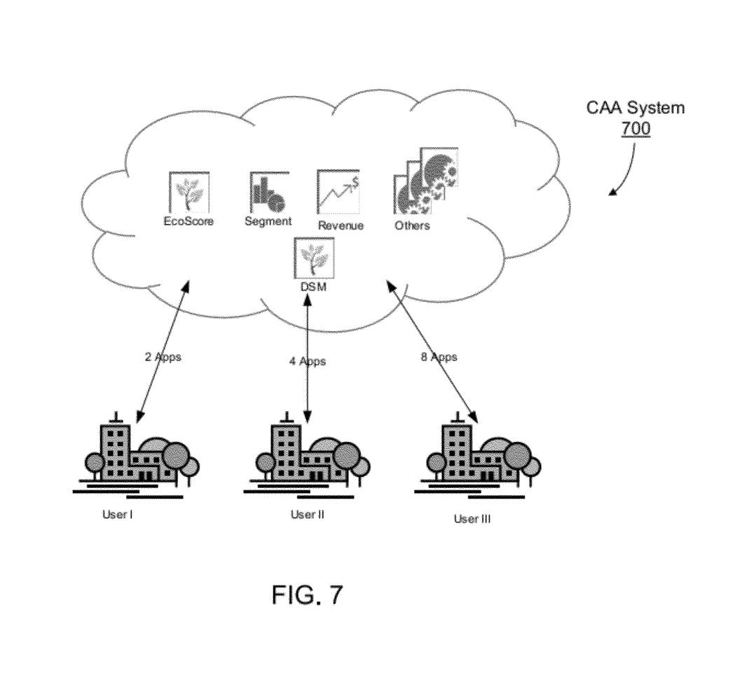

FIG. 7 shows CAA system 700, according to an embodiment. The CAA system 700 may exist in a cloud computing environment in which users access the suite of applications in the cloud or as an internal system. Different users may access the same or different applications, in differing amounts. For example, User I accesses two applications, User II accesses four applications and User III accesses eight applications.

The CAA system 700 may utilize existing data feeds and/or sources where possible with point-to-point integration. The CAA system 700 may provide a repository for all demand side management activities. The CAA system 700 may provide work flow templates and business user configuration options to support multiple types of implementations which are highly configurable by the CAA system user.

The CAA system 700 may be utilized separately or in combination with systems of a company or service organization with a broad customer base, such as a utility company. The CAA system 700 may provide robust and actionable customer segmentation. It may also provide collection analytics which may be utilized to develop programs to improve customer payment collections and credit. It may also provide identification of “likely self-serve” customers and promote online and other self-serve channels to reduce cost to serve. It may also implement the functionality of the DSM portfolio management system 100, including providing propensity models for DSM programs to improve adoption and reduce administration costs. It may accomplish these things while enabling the targeting of customers at a strategic level. This may also improve customer satisfaction, such as by scheduling preventative maintenance on assets such as planned outages which are optimized around customer needs.

The CAA system 700 may also provide field service improvements using optimal scheduling and efficient issue logs for an improved customer experience. In one embodiment, the CAA system 700 may include the integration of third party data and operate in a cloud computing environment. Thus, no major infrastructure and/or technology investment is required by CAA system users.

The CAA system 700 may perform analytics to analyze a customer base. The CAA system 700 combines analytics with modules and workflow supporting analysis. It supports quality improvement functions of company or organization and combines analytics with application and workflow capabilities to provide a method of modeling and measuring aspects of the customer base.

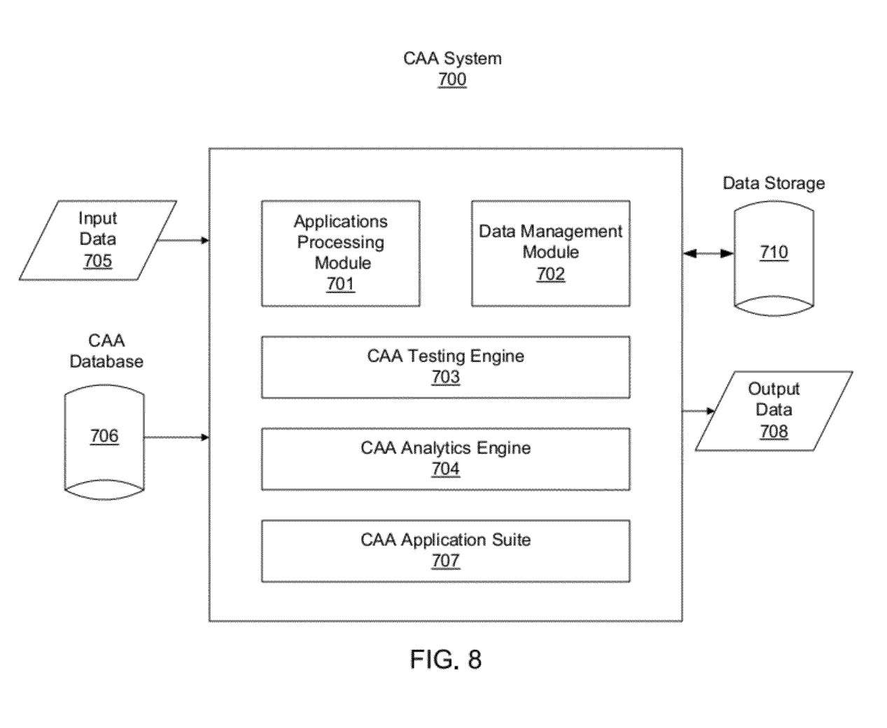

A block diagram of the CAA system 700, according to an embodiment, is shown in FIG. 8. The CAA system 700 enables users to effectively perform precise, accurate and efficient CAA testing and analysis. The CAA system 700 may include an applications processing module 701, a data management module 702, a CAA testing engine 703, a CAA analytics engine 704, a CAA application suite, including one or more individual applications described below and a data storage 710. The CAA system 700 receives input data 705 about a customer base, such as parameters associated with categories and subcategories to be included in a factor profile. Other input data 705 may include a customer data table containing data fields for a customer identity and for the categories and subcategories associated with the customer identity. The output data 708 may include results such as from the CAA testing engine 703 or the CAA analytics engine 704. The output data 708 may be viewed via a portal or dashboard and/or stored in the data storage 710.

The CAA system 700 may also receive data or parameters from a CAA database 706. The CAA database 706 provides CAA data associated with the different applications utilized in analyzing the customer base. It may also interface with community or third party databases for collaboration. The CAA system 700 processes the various inputs and transmits output data 708, generally, through the data management module 702.

The CAA testing engine 703 may be utilized to compare, test and measure the input data 705 against parameters generated through the applications processing module 701. The CAA testing engine 703 may also generate feedback data utilized by the CAA analytics engine 704. The CAA analytics engine 704 may be utilized for developing outcome drivers, and to evaluate feedback data developed utilizing a closed loop with the CAA testing engine 703. This closed loop may generate feedback data utilized in the CAA analytics engine 704 to enhance the development of new customer profiles or customer base segmentations.

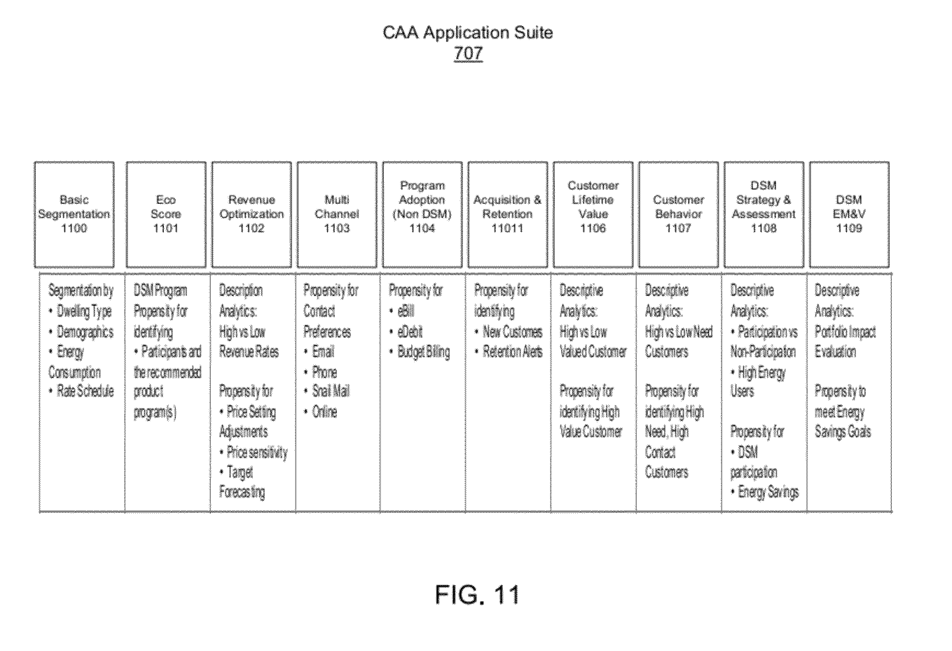

Various exemplary applications 1100-1109 in the CAA application suite 707 are now described in detail. Referring to FIG. 11, all the applications 1100-1109 are shown in the CAA application suite 707, according to an example. These applications may be used in any combination and the CAA application suite 707 may include other applications. Also, examples of the number of variables, number of reports and types of analytics for each application is described, however, the numbers and types may vary from the examples.

The Basic Segmentation application 1100 performs customer segmentation based upon attributes such as dwelling type, demographics, energy consumption, rate schedule, etc. This application may have a descriptive algorithm and may utilize approximately 50 input variables of different types from various sources, including customer information system (CIS), 25 elements, demographics/census, 15 elements and firmographics, 10 elements.

The EcoScore application 1101 identifies DSM program propensity across a customer base. This is a composite application having multiple algorithms, each of which addresses a specific DSM program or DSM question. This may include algorithms such as propensity for energy efficiency, propensity for solar, propensity for rebates, etc. This application may include 10-12 predictive algorithms. It may use approximately 150 input variables of different types from various sources, including CIS, 50 elements, demographics/census, 15 elements, firmographics, 10 elements, DSM, 20 elements, real estate, 15 elements, weather/climate 10 elements, interactive voice response (IVR), 20 elements, and web statistics, 10 elements. This application may require 2-5 specific reports which can be run either as one-offs, or for all the algorithms in summary.

The Revenue Optimization application 1102 identifies revenue optimization opportunities or hindrances within the customer base. This includes algorithms such as propensity for price setting adjustments, propensity for price sensitivity, and propensity for target forecasting. The application may be made up of 1-2 descriptive and 3-5 predictive algorithms. It may use approximately 65 input variables of different types from various sources, including (approximately) CIS, 25 elements, demographics/census, 15 elements, firmographics, 10 elements, and real estate, 15 elements. This application may require 2-5 specific reports which can be run either as one-offs, or for all the algorithms in summary.

The Multi-Channel application 1103 identifies the propensity toward a given channel type within the customer base. It evaluates across propensity for e-mail, propensity for postal mail, propensity for phone (in-coming & out-going), propensity for web and propensity for self service. The application may be made up of (5-7) predictive algorithms and use approximately 105 input variables of different types from various sources, including (approximately) CIS, 25 elements, demographics/census, 15 elements, firmographics, 10 elements, real estate, 15 elements, weather/climate, 10 elements, IVR, 20 elements and web statistics, 10 elements. This application may require 2-5 specific reports which can be run either as one-offs, or for all the algorithms in summary.

The Program Adoption (Non-DSM) application 1104 identifies the propensity toward customer adoption of various programs offered by the user, such as a utility company, including propensity for e-bill, propensity for direct debit, propensity for budget billing, propensity for donation, etc. This application is made up of (5-7) predictive algorithms and uses approximately 65 input variables of different types from various sources, including (approximately) CIS, 25 elements, demographics/census, 15 elements, firmographics, 10 elements, and real estate, 15 elements. This application requires 2-5 specific reports which can be run either as one-offs, or for all the algorithms in summary.

The Acquisition and Retention application 1105 identifies the propensity toward customer behavior in joining or leaving the utility, such as propensity for new customer, propensity for retention issue, etc. This application may be made up of (2-4) predictive algorithms and may use approximately 55 input variables of different types from various sources, including (approximately) CIS, 25 elements, demographics/census, 15 elements, firmographics, 10 elements and customer satisfaction, 5 elements. This application may require 2-5 specific reports which can be run either as one-offs, or for all the algorithms in summary.

The Customer Lifetime Value application 1106 identifies customer value (e.g., high or low) and the propensity for change, propensity for customer to be high value, etc. This application may be made up of (1-2) descriptive and (1-2) predictive algorithms. It may use approximately 45 input variables of different types from various sources, including (approximately): CIS, 25 elements, demographics/census, 15 elements and customer satisfaction, 5 elements. This application may generate 2-5 specific reports which can be run either as one-offs, or for all the algorithms in summary.

The Customer Behavior (Chronic) application 1107 identifies the evaluation of customer behavior (high or low need) and the propensity for change in behavior, propensity for customer to be high contact, etc. This application may include (1-2) descriptive and (2-3) predictive algorithms. It may use approximately input variables of different types from various sources, including (approximately): CIS, 25 elements, demographics/census, 15 elements and customer satisfaction, 5 elements. This application may generate 2-5 specific reports which can be run either as one-offs, or for all the algorithms in summary.

The DSM Strategy and Assessment application 1108 identifies the evaluation of customer behavior (participation and high energy use) and the propensity for behavior, such as DSM participation, energy savings, etc. The applications 1108 and 1109 may perform at least some of the functionality DSM portfolio management system 100. The application 1108 may include (1-2) descriptive and (2-3) predictive algorithms. It may use approximately 150 input variables of different types from various sources, including (approximately): CIS, 50 elements, demographics/census, 15 elements, firmographics, 10 elements, DSM, 20 elements, real estate, 15 elements, weather/climate, 10 elements, IVR, 20 elements, and web statistics, 10 elements. This application may generate 2-5 specific reports which can be run either as one-offs, or for all the algorithms in summary.

The DSM Evaluation, Measurement and Verification (EM&V) application 1109 identifies the DSM portfolio impact of customer behavior and the propensity for the behavior to facilitate objectives, such as meeting energy savings goals, etc. This application may include (1-2) descriptive and (1-2) predictive algorithms. It may use approximately 150 input variables of different types from various sources, including (approximately) CIS, 50 elements, demographics/census, 15 elements, firmographics, 10 elements, DSM, 20 elements, real estate, 15 elements, weather/climate, 10 elements, IVR, 20 elements, and web statistics, 10 elements. This application may require 2-5 specific reports which can be run either as one-offs, or for all the algorithms in summary.

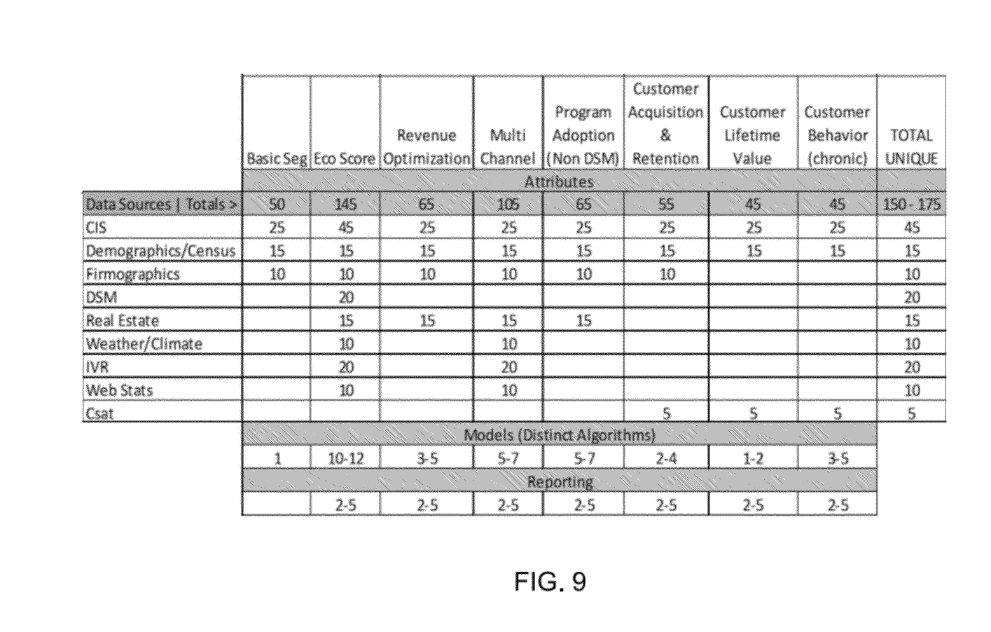

FIG. 9 shows examples of types of attributes for eight applications, such as Basic Segmentation 1100, EcoScore 1101, Revenue Optimization 1102, Multi-Channel 1103, Program Adoption (Non-DSM) 1104, Acquisition and Retention 1105, Customer Lifetime Value 1106 and Customer Behavior 1107. An example of a number of attributes for each type is shown. For instance, Basic Segmentation 500 may have 50 total attributes, including 25 CIS attributes. EcoScore 501 has 145 total attributes, including 45 CIS attributes. FIG. 9 also shows examples of the number of models and reports.

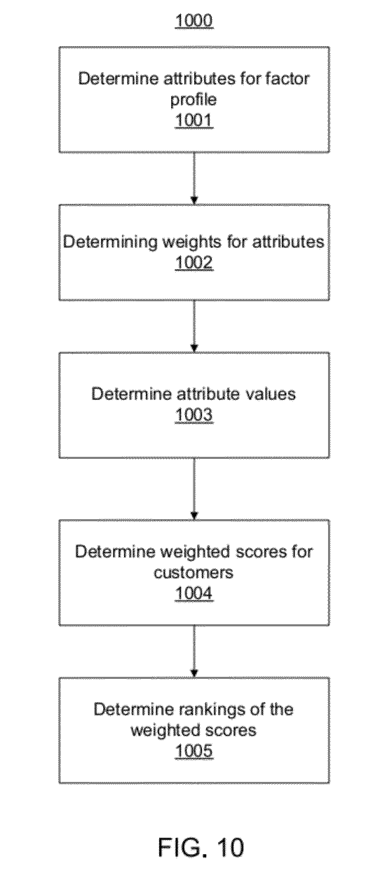

FIG. 10 illustrates a method 1000, according to an embodiment, for analyzing a customer base. The method may be performed by the CAA system 700. The customers in the customer base may have a stored factor profile made up of categories and subcategories, including an assigned weight in a model associated with the customer base.

At block 1001, attributes to be included in the factor profile are determined. The attributes describe each customer, and examples of types of attributes are described with respect to FIG. 9. The attributes to be included may be selected by a user and stored in the CAA system 700.

At block 1002, respective weights assigned to each of the attributes are determined. Weights may be determined by analyzing historic customer data to estimate how much each of the attributes impacts the objectives or goals of the applications in the CAA application suite 707. Weights may be determined for each of the applications or for the entire suite of applications.

At block 1003, values for the attributes are determined. The values may be stored in a customer data table containing data fields for a customer identity and their attributes. The customer data table may be stored in the CAA database 706

At block 1004, a weighted score for each customer is determined, and, at block 1005, a ranking of the weighted scores for each customer is determined. The weighted score may be determined by summing the weights for each customer. A weighted score may be determined for each of the applications in the CAA application suite 707. Each weighted score may indicate a degree of propensity of the customer. The propensity may be related to each application. For example, a score may indicate a propensity of a customer to participate in a DSM program or a propensity for adoption for different energy saving tactics. The ranking may include a ranking of high to low or vice versa.

Some or all of the methods and operations and functions described above may be provided as machine readable instructions, such as computer programs, stored on a computer readable storage medium, which may be non-transitory such as hardware storage devices or other types of storage devices. For example, they may exist as program(s) comprised of program instructions in source code, object code, executable code or other formats. An example of computer readable storage media includes a RAM, ROM, EPROM, EEPROM, hard drivers, etc.

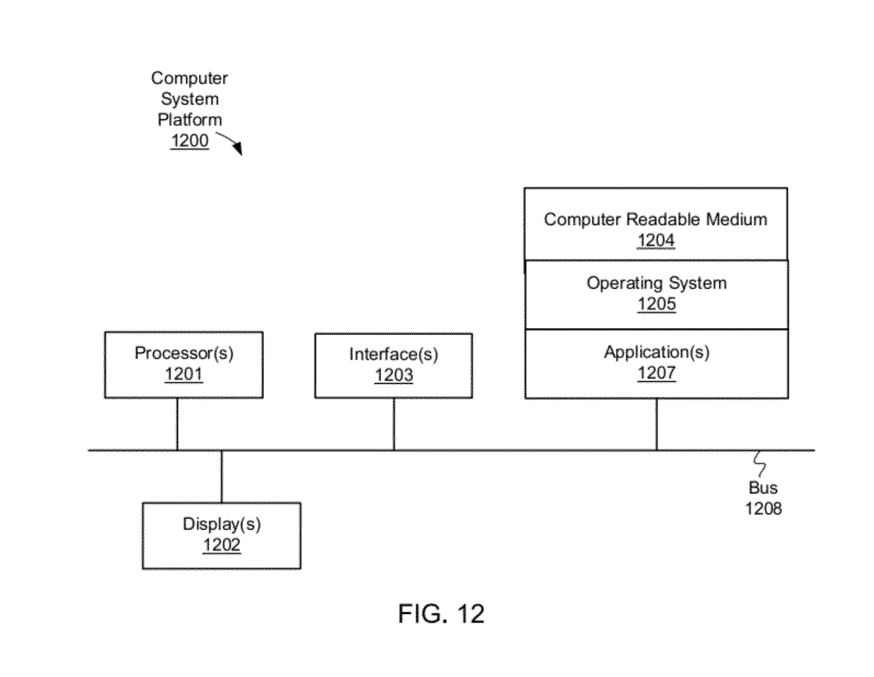

Referring to FIG. 12, there is shown a computer system 1200 that may be a computer platform for the DSM portfolio manager system 100 and/or the CAA system 700. It is understood that the illustration of the computer system 1200 is a generalized illustration and that the computer system 1200 may include additional components and that some of the components described may be removed and/or modified. Also, the DSM portfolio manager system 100 and/or the CAA system 700 may be implemented in a distributed computing system, such as a cloud computer system.

The computer system 1200 includes processor(s) 1201, such as a central processing unit, ASIC or other type of processing circuit; a display 1202, such as a monitor; an interface 1203, such as a simple input interface and/or a network interface to a Local Area Network (LAN), a wireless 802.11x LAN, a 3G or 4G mobile WAN or a WiMax WAN; and a computer-readable medium 1204. Each of these components may be operatively coupled to a bus 1208. A computer readable medium (CRM), such as CRM 1204 may be any suitable medium which participates in providing instructions to the processor(s) 1201 for execution. For example, the CRM 1204 may be non-transitory or non-volatile media, such as a magnetic disk or solid-state non-volatile memory or volatile media such as RAM. The instructions stored on the CRM 1204 may include machine readable instructions executed by the processor 1201 to perform the methods and functions of the DSM portfolio manager system 100 and/or the CAA system 700.

The CRM 1204 may store an operating system 1205, such as MAC OS, MS WINDOWS, UNIX, or LINUX, and applications 12012. The operating system 1205 may be multi-user, multiprocessing, multitasking, multithreading, real-time and the like. The operating system 1205 may also perform basic tasks such as recognizing input from the interface 1203, including from input devices, such as a keyboard or a keypad; sending output to the display 1202 and keeping track of files and directories on CRM 1204; controlling peripheral devices, such as disk drives, printers, image capture device; and managing traffic on the bus 1208. The applications 12012 may include applications performing the functions of the DSM portfolio manager system 100 and/or the CAA system 700. In certain examples, processes may be at least partially implemented in digital electronic circuitry, in computer hardware, firmware, code, instruction sets, or any combination thereof.

While the embodiments have been described with reference to examples, those skilled in the art will be able to make various modifications to the described embodiments without departing from the scope of the claimed embodiments.

What is claimed is:

1. A demand side management (DSM) portfolio manager system for processing DSM data to implement DSM programs for an energy service provider, the system comprising:
a DSM workflow management module to determine a workflow plan for processing the DSM data throughout phases of a DSM portfolio lifecycle to create and evaluate the DSM programs for the energy service provider, wherein the phases of the DSM portfolio lifecycle include strategy and assessment, program planning and design, delivery and execution, and evaluation, measurement and verification;
a DSM evaluation, measurement and verification module executed by a processor to evaluate the DSM programs in the evaluation, measurement and verification phase of the DSM portfolio lifecycle, wherein the evaluation of the DSM programs includes determining key performance indicators for the DSM programs based on the DSM data and comparing the DSM programs to benchmarks and further includes analyzing the DSM data for the DSM programs utilizing performance-based analytics to predict future performance of the DSM programs; and
a DSM reporting module to report results of the evaluation in a dashboard.

2. The DSM portfolio manager system of claim 1, comprising:
a data integration and communication module comprising interfaces to collect at least some of the DSM data from internal systems of the energy service provider and format the at least some of the DSM data according to a predetermined schema, and to store the formatted DSM data in a data repository for the DSM portfolio manager system.

3. The DSM portfolio manager system of claim 2, wherein the internal systems comprise at least some of an accounting application, customer information system application, a meter data management application, an enterprise resource planning application, a customer relationship management application, a geographic information system application, a smart metering application, a capacity planning application, and a workforce management application.

4. The DSM portfolio manager system of claim 2, wherein the data integration and communication module comprising interfaces to collect at least some of the DSM data from third party vendors and vendor systems.

5. The DSM portfolio manager of claim 1, further comprising the DSM workflow management module receiving definitions of the KPIs via the dashboard and using the definitions to calculate the KPIs for the comparison to the benchmarks.

6. The DSM portfolio manager system of claim 2, wherein the data repository stores DSM data for a plurality of users, and the benchmarks are determined from the DSM data for the plurality of users.

7. The DSM portfolio manage system of claim 6, wherein the DSM workflow management module, in the strategy and assessment phase and in the program planning and design, determines models of DSM programs from the DSM data for the plurality of users in the repository and uses the models to select the DSM programs for the energy service provider.

8. The DSM portfolio manager of claim 7, wherein the DSM workflow management module collects data about the energy service provider and based on the collected data and the models, and selects the DSM programs for the energy service provider to implement that are most likely to be successful.

9. The DSM portfolio manager system of claim 1, wherein the DSM reporting module presents reporting templates to the energy service provider via the dashboard for customization.

10. The DSM portfolio manager system of claim 1, wherein the DSM portfolio manager system performs DSM auditing, rebate claim processing and promotion of energy conservation information, wherein the DSM auditing includes calculating energy loss or energy savings based on energy usage information determined for a user.

11. A demand side management (DSM) method for processing DSM data through phases of a DSM portfolio lifecycle, the method comprising:
determining types of DSM programs to implement for an energy service provider based on information about the energy service provider and based on DSM data collected for a plurality users related to DSM programs that have previously been implemented;
determining details of the DSM programs to implement;
collecting DSM data after implementing the DSM programs;
evaluating, by a processor, the DSM programs, wherein the evaluation of the DSM programs includes determining key performance indicators for the DSM programs based on the collected DSM data, comparing the DSM programs to benchmarks, and analyzing the DSM data for the DSM programs utilizing performance-based analytics to predict future performance of the DSM programs; and
reporting results of the evaluation via a dashboard.

12. The method of claim 11, comprising:
collecting at least some of the DSM data from internal systems of the energy service provider;
formatting the at least some of the DSM data according to a predetermined schema; and
storing the formatted DSM data in a data repository for the DSM portfolio manager system.

13. The method of claim 12, wherein the internal systems comprise at least some of an accounting application, customer information system application, a meter data management application, an enterprise resource planning application, a customer relationship management application, a geographic information system application, a smart metering application, a capacity planning application, and a workforce management application.

14. The method of claim 12, comprising:
providing interfaces to collect at least some of the DSM data from third party vendors and vendor systems.

15. The method of claim 12, wherein the data repository stores DSM data for a plurality of users, and the method comprises determining the benchmarks from the DSM data for the plurality of users.

16. The method of claim 15, comprising:
determining models of DSM programs from the DSM data for the plurality of users in the repository; and
using the models and the information about the energy service provider to select the DSM programs to implement.

17. The method of claim 11, wherein the DSM programs promote energy conservation.

18. A non-transitory computer readable medium storing computer readable instructions that when executed by a computer system perform a demand side management (DSM) method comprising:
determining types of DSM programs to implement for an energy service provider based on information about the energy service provider and based on DSM data collected from a plurality users related to DSM programs that have previously been implemented;
determining details of the DSM programs to implement;
collecting DSM data after implementing the DSM programs;
evaluating the DSM programs, wherein the evaluation of the DSM programs includes determining key performance indicators for the DSM programs based on the collected DSM data, comparing the DSM programs to benchmarks, and analyzing the DSM data for the DSM programs utilizing performance-based analytics to predict future performance of the DSM programs; and
reporting results of the evaluation via a dashboard.

19. The non-transitory computer readable medium of claim 18, wherein the method comprises:
collecting at least some of the DSM data from internal systems of the energy service provider;
formatting the at least some of the DSM data according to a predetermined schema; and
storing the formatted DSM data in a data repository for the DSM portfolio manager system.

20. The non-transitory computer readable medium of claim 18, wherein the DSM programs promote energy conservation.
